(19) United States
(12) Patent Application Publication
(10) Pub. No.: US 2025/0134145 A1
(43) Pub. Date: May 1, 2025

(54) NON-DAIRY FORMULAE FOR USE IN IMPROVING GROWTH AND TOLERANCE IN A SUBJECT IN NEED THEREOF

(71) Applicant: ELSE NUTRITION GH LTD, TEL AVIV (IL)

(72) Inventors: Uriel KESLER, TEL AVIV (IL); Hamutal YITZHAK, TEL AVIV (IL); Fabiana BAR YOSEPH, Haifa (IL); Michael AZAR, Beit Yitzhak (IL); Kayla BRIDGES, Huntington Woods, MI (US); Renana MIZRAHI, Gedera (IL)

(73) Assignee: ELSE NUTRITION GH LTD, TEL AVIV (IL)

(21) Appl. No.: 18/797,571

(22) PCT Filed: Feb. 8, 2023
(86) PCT No.: PCT/IL2023/050136

§ 371 Date: Sep. 8, 2024

Related U.S. Application Data
(60) Provisional application No. 63/308,088, filed on Feb. 9, 2022.

(51) Int. Cl. A23L 25/00; A23L 2/39; A23L 2/68; A23L 33/00; A23L 33/175

(52) U.S. Cl. CPC A23L 25/00; A23L 2/39; A23L 2/68; A23L 33/175; A23L 33/40

(57) ABSTRACT

The present invention provides a composition comprising almond and at least one non-dairy component comprising all essential amino acids, wherein said composition is a non-dairy composition for use in the nutrition of a subject suffering from disorders and in need of vitamin absorption support and microbiome development.

### BACKGROUND

A balanced diet with adequate nutrients is essential for normal growth. Balanced diet includes lipids, carbohydrates, protein, vitamins, minerals. Infants and young children consume formulas that are designed to fulfil those needs.

Infant formula is a manufactured food designed and marketed for feeding babies and infants under 12 months of age, usually prepared for bottle-feeding or cup-feeding from powder (mixed with water) or liquid (with or without additional water). The U.S. Federal Food, Drug, and Cosmetic Act (FFDCA) defines infant formula as “a food which purports to be or is represented for special dietary use solely as a food for infants by reason of its simulation of human milk or its suitability as a complete or partial substitute for human milk”.

A 2001 World Health Organization (WHO) report found that infant formula prepared in accordance with applicable Codex Alimentarius standards was a safe complementary food and a suitable breast milk substitute.

The composition of infant formula is designed to be roughly based on a human mother's milk at approximately one to three months postpartum, although there are significant differences in the nutrient content of these products. Most formulas for infants and young children are based on animal proteins, usually based on cow milk with a minority that are plant usually based on soy. The most commonly used infant formulas contain purified cow's milk whey and casein and/or skimmed milk powder as a protein source, a blend of vegetable oils as a fat source, lactose as a carbohydrate source, a vitamin-mineral mix, and other ingredients depending on the manufacturer.

Though those formulas are supposed to support growth, Failure to thrive (FTT) is observed in infants and young children and may be a result of nutrition, diseases, medical problems, or factors in the child's environment. Gastrointestinal problems that interfere with nutrients absorption; allergies, intolerances, chronic infections; metabolic disorders, unavailability of proper diet, exposure to infections, poor eating habits, etc. may lead to poor weight gain and even failure to thrive. Failure to thrive is not a disease but a symptom that accompanies an underlying disease with the pathogenesis of malnutrition. Insufficient food intake is common with many chronic diseases and is usually associated with lack of appetite, chronic vomiting, swallowing and chewing disorders, esophageal dysmotility or shortness of breath with heart and lung diseases. Malabsorption during childhood is a common cause of malnutrition.

In young children failure to thrive may result from insufficient food intake, intestinal allergy to cow's milk protein, esophagitis with gastroesophageal reflux, cystic fibrosis, eating disorders and/or increased energy requirements, Celiac disease, chronic diarrhea in cases of immune-system defects, chronic inflammatory intestinal diseases, etc.

As most of the infant formulas are based on cow's milk whey and casein as a protein source, many babies develop allergy or intolerance conditions that may be at times, life threatening.

Food allergies are a growing food safety and public health concern that affect an estimated 8% of children in the United States (https://www.cdc.gov/healthyschools/foodallergies/index.htm). A food allergy occurs when the body has a specific and reproducible immune response to certain foods (IgE mediated). There is no cure for food allergies. Strict avoidance of food allergens is the only way to prevent a reaction. The symptoms and severity of allergic reactions to food can be different between individuals and can also be different for one person over time.

Over the last decade, food allergy research mainly focused on the timing of food introduction and oral tolerance. A large amount of evidence demonstrated that an early introduction of allergens might protect against the risk of developing IgE-mediated food allergy.

In the last years, an increasing scientific interest focused on the diagnosis of non-IgE mediated food allergy, which often presents with a delayed onset of gastrointestinal symptoms (colic, vomiting, regurgitation, diarrhea, and constipation).

Food-protein induced enterocolitis syndrome (FPIES) is a non-IgE-mediated reaction mostly seen in infants and children, where an abnormal response to a food result in gastrointestinal inflammation and increased intestinal mucosal permeability. Unlike other food-allergic reactions that can trigger an allergic response throughout the body, the symptoms of FPIES typically are confined to the gastrointestinal system such as: Severe vomiting, Diarrhea (sometimes bloody), Weight loss, Dehydration, Lack of energy, Failure to thrive, etc.

The clinical presentation of FPIES is primarily vomiting and diarrhea, which can be acute or chronic and resolution is usually observed within 24-48 h. Vomiting is the most common symptom, being reported in more than 95% of the cases. It usually occurs 0.5-6 h post ingestion (average 2 h) and is characterized by frequent projectile episodes, every 10-15 min. Loose or watery diarrhea occurs in 20-50% of patients, usually about 6 h after ingestion of the causative food, but can be more delayed up to 16 h. Bloody diarrhea has been reported as well.

FPIES symptoms begin early in life, typically occurring after the introduction of milk-or soy-based formulas. Early on, infants tend to have poor growth and might be diagnosed with failure to thrive. Older infants can present with solid food FPIES, typically when an infant starts eating rice, oats, barley, and other similar foods. This generally occurs after 4 months of age.

Although it is an allergy, it cannot be identified through the usual skin-prick or blood tests for food allergies. Allergy tests are typically negative to the offending trigger food. The primary treatment is strict avoidance of the triggering food. Most children outgrow FPIES by age 3 or 4.

Eosinophilic esophagitis (EoE) is an inflammatory condition of the esophagus that constitutes the most prevalent cause of chronic esophagitis after gastroesophageal reflux disease (GERD) and the leading cause of dysphagia and food impaction in children and young adults. EoE represents an important contributor to upper gastrointestinal morbidity throughout the world, a growing health problem, and a significant burden for healthcare systems. It belongs to the spectrum of eosinophilic gastrointestinal disorders where the inflammation of the gastrointestinal tract occurs in the absence of secondary causes. In the last 20 years, a large number of epidemiological studies showed a significant increase of incidence and prevalence of EoE especially in children in Western Countries. This interesting phenomenon might be related to (1) an overall increased incidence of allergic and non-allergic diseases, (2) the chronic disease-course of EoE, and (3) the improved medical awareness and knowledge.

The efficacy of food elimination diets varies. The most common and best described is the ‘six-food elimination diet’ that removes dairy, wheat, egg, soy, peanut/tree nut, and fish/shellfish. Elemental diets such as amino acids-based formulas result in remission in most patients. However, significant obstacles limit the use of amino acid formula, including taste, limited meal variety, lack of insurance coverage, etc.

Gastrointestinal symptoms are not always related to allergies or a specific food reaction. Functional gastrointestinal disorders (FGIDs), such as irritable bowel syndrome (IBS), functional abdominal pain, and functional dyspepsia are prevalent. These disorders often cause significant morbidity and lead to school absences, increased use of health care resources, and decreased quality of life (QOL).

The etiology of FGIDs is thought to be multifactorial including altered brain-gut interactions, genetic predispositions, and/or environmental factors such as diet. Avoidance of certain foods may improve GI symptoms as demonstrated through dietary interventions, promoting avoidance of foods high in fermentable oligosaccharides, disaccharides, monosaccharides, and polyols (FODMAPs) in some adults with FGIDs. However, dietary restrictions without medical supervision may reduce their intake of important nutrient-containing foods and impair overall nutrition.

Skin rashes are common in childhood. Sometimes they might be a result of a food allergy and sometimes it is not related to food. Eczema is a long-term condition that causes the skin to become itchy, red, dry and cracked. The most common type is atopic eczema, which mainly affects children but can continue into adulthood. Atopic dermatitis is a common childhood inflammatory skin disease that affects approximately 20% of children in the United States.

For formula fed infants, milk substitute formulas are used to provide a complete source of nutrition. Milk substitutes include soy-based formulas; hypoallergenic formulas based on partially or extensively hydrolyzed protein, and free amino acid-based formulas.

Non-milk derived amino acid-based formulas, known as amino acid formulas or elemental formulas, are considered the gold standard in the treatment of cow's milk allergy when the mother is unable to breastfeed.

Hydrolyzed formulas come in partially hydrolyzed and extensively hydrolyzed varieties. Partially hydrolyzed formulas (PHFs) are characterized by a larger proportion of long chain peptides and are considered more palatable. However, they are intended for milder cases and are not considered suitable for treatment of moderate to severe milk allergy or intolerance. Extensively hydrolyzed formulas (EHFs) are composed of proteins that have been largely broken down into free amino acids and short peptides. Casein and whey are the most commonly used sources of protein in hydrolyzed formulas because of their high nutritional quality and their amino acid composition.

Soy based formula may or may not pose a risk of allergic sensitivity, as some infants who are allergic to milk may also be allergic to soy. Also, soy-based formulas are not recommended for infants under 6 months.

Infant formulas also come in a variety of types: Cow's milk formula is the most used type (e.g.: Similac, Enfamil). Soy protein-based formulas are frequently used for infants allergic to cow's milk (e.g.: Isomil, ProSobee). Partially hydrolyzed formulas (e.g.: Good Start and Gentlease brands) are marketed as having improved digestibility. Extensively hydrolyzed formulas (e.g.: Alimentum, Nutramigen, and Pregestimil) are considered “hypoallergenic”. One study reported that 90% of children with cow's milk allergies will tolerate them. Amino acid based formulas (e.g.: Neocate, EleCare, and Nutramigen AA) are more expensive, but are reported least likely to cause allergic reactions.

Hypoallergenic formulas, such as those containing free individual amino acids, and sometimes referred to as elemental infant formula, are considered to reduce the likelihood of certain medical complications in babies with specific health problems, such as severe allergies to cow's milk and soy. Made of purely synthetic monomeric amino acids, they are often considered quite foul-tasting, and it is not uncommon for infants to reject elemental formulas after having been established on a sweeter-tasting regular formula, thus the level of compliance of infants in an age wherein feeding is crucial, such incompliance is life threatening.

SPIFs (Soy Protein Infant contain phytoestrogens, mostly isoflavonoids (particularly diadzein, genistein). It was shown that these substances tend to bind to estrogen receptors and behave as pro-or anti-estrogens. The amount of phytoestrogen in SPIF (32-47 mg/liter) is 40 times higher than the amount in breast milk. Consumption of isoflavonoids from SPIF reaches 11 mg/kg body weight per day, and their levels in infant blood were 13,000 to 22,000 times higher than the blood levels of estrogen-like substances in the first years of life. Infants who are fed only on SPIF are exposed to a daily consumption of isoflavonoids that is 4-13 times the amount presumed to have a physiological effect on balancing the menstrual cycle in women. Recently the scientific literature has raised some concerns regarding the vast consumption of SPIFs regarding the fact that phytoestrogens could have an adverse effect on infant and child growth (they are not recommended for premature infants weighing less than 1800 grams), development and puberty, bone health and thyroid function. In addition, the fact that most of the soy crops are genetically engineered the use of SPIF is not recommended in certain countries and is regulated to the extent of requiring a prescription for administration for infants having severe allergies.

There is therefore a true need in the art for a non-dairy formula that can provide all essential nutritional needs and be safe and tolerable nutrition to a subject suffering from a growth problem, a digestive and/or gastric disorder, problems with blood glucose control disease and symptoms thereof.

### GENERAL DESCRIPTION

In the first aspect the invention provides a composition comprising almond and at least one non-dairy component comprising all essential amino acids, wherein said composition is a non-dairy composition for use in the nutrition of subject suffering from at least one condition selected from skin problem, frequent rashes, frequent loose stool, frequent hard stool, constipation, growth problem, poor weight gain, failure to thrive, uncontrolled blood glucose, hyperglycemia, allergy, intolerance, gastrointestinal disorders and any combinations thereof.

In another aspect the invention provides a composition comprising almond and at least one non-dairy component comprising all essential amino acids, wherein said composition is a non-dairy composition for use in the nutrition of subject in need of vitamin absorption support and microbiome development.

In a further aspect the invention provides a composition comprising almond and at least one non-dairy component comprising all essential amino acids, wherein said composition is a non-dairy composition formula for use in the treatment and/or prevention of at least one condition selected from skin problem, frequent rashes, frequent loose stool, frequent hard stool, constipation, growth problem, poor weight gain, failure to thrive, uncontrolled blood glucose, hyperglycemia, and any combinations thereof.

When referring to a “subject” it should be understood to encompass a newborn neonate, a toddler, a child, an adolescent, an adult, an elderly, healthy or in any medical condition such as one with poor weight gain, failure to thrive, malnourished, suffering from Food-protein induced enterocolitis syndrome (FPIES), suffering from Functional gastrointestinal disorders (FGIDs), suffering from irritable bowel syndrome (IBS), suffering from EOE, suffering from non-IgE mediated food allergy, suffering from IgE mediated food allergy, suffering from Disease Related Malnutrition (DRM), suffering from any food intolerance, suffering from lactose intolerance, suffering from any food allergy, such as cow milk protein allergy (CMA), soy protein allergy, corn allergy.

When referring to an “infant” it should be understood to encompass a newborn neonate between the ages of 0 and 1 year old. This term includes both full term and premature neonates at any body weight.

When referring to a “toddler” it should be understood to encompass a human between the ages of 1 and 3 years. This term includes humans in this age range at any cognitive or health condition.

When referring to a “child” it should be understood to encompass a human between the ages of 3 and 18 years. This term includes humans in this age range at any cognitive or health condition.

When referring to “nutrition of subject suffering from at least one condition” it should be understood to encompass the ability of said composition to provide nutrition to a subject suffering from the conditions and symptoms disclosed, that due to those conditions and/or symptoms said subject is having difficulty keeping healthy, balanced, diverse and full nutritional intake of food.

In some embodiments, said subject is nourished by a plant-based non-dairy nutrition (the sole nutrition of said subject is a plant-based non-dairy nutrition). In other embodiments, said subject is nourished by a plant-based non-soy nutrition (the sole nutrition of said subject is a plant-based non-soy nutrition).

When referring to subject “suffering from a growth problem”, it should be understood to relate to an infant, a toddler, a child, or an adolescent, suffering from a too low weight, poor weight gain, failure to thrive, too short length/height according to growth charts for the age and sex.

When referring to subject “suffering from a condition of frequent rashes”, it should be understood to relate to an infant, a toddler, a child, an adolescent, an adult or an elderly suffering from a skin reaction, a skin rash, or an eczema.

When referring to a subject “suffering from a condition of frequent loose stool” it should be understood to relate to an infant, a toddler, a child, an adolescent, an adult or an elderly suffering frequent defecation, more than 3-4 stools per day, diarrhea, or watery stool.

When referring to subject “suffering from a gastrointestinal disorder”, it should be understood to relate to an infant, a toddler, a child, or an adolescent, suffering from a symptom related to the gastrointestinal system, such as spit ups, flatulence, vomit, reflux, regurgitation, problems swallowing, feeding problems.

When referring to a subject “suffering from a condition of uncontrolled blood glucose” it should be understood to relate to an infant, a toddler, a child, an adolescent, an adult or an elderly suffering from too low or too high or unbalanced blood glucose levels relative to the norm for the specific age and condition.

When referring to a subject “suffering from a condition of hypo or hyperglycemia” it should be understood to relate to an infant, a toddler, a child, an adolescent, an adult or an elderly suffering from too low or too high or unbalanced blood glucose levels relative to the norm for the specific age and condition.

When referring to a “growth problem” it should be understood to encompass a growth disturbance; a growth disorder; failure to thrive; abnormal growth related condition, insufficient growth; insufficient growth rate; reduced growth rate; insufficient growth parameters; insufficient growth and/or growth rate and/or growth parameter/s compared to acceptable norms at the specific subject's age and/or gender and/or weight and/or health condition/s and the like.

When referring to a “improved growth” or “improving growth” or “improvement in the growth” it should be understood as one or more of maintaining normal growth rate (as accepted for gender and for age group of subjects (e.g., infants) based on growth charts from WHO (World Health Organization) or CDC (Center for Disease Control)); enhancing/increasing growth rate; increasing weight gain; reducing poor weight gain, facilitating catch up growth, better growth of a subject in comparison to the growth of the subject prior to the administration of the composition according to the present invention.

When referring to a “skin condition” it should be understood to encompass any skin rash, red itchy rash, eczema, atopic dermatitis, or any combination thereof.

When referring to a “gastrointestinal disorder” or “gastrointestinal problem” it should be understood to encompass any symptom related to the gastrointestinal system, such as spit ups, flatulence, vomit, reflux, regurgitation, problems swallowing, feeding problems, or any combination thereof.

When referring to an “unbalanced glucose level” it should be understood to encompass too low or too high blood glucose according to the norms for the specific subject or unstable blood glucose level.

When referring to “improving stool consistency” it should be understood to encompass change in stool consistency from runny or watery or hard or formed stool to a normal shape one as for example described by Bristol scale (https://www.webmd.com/digestive-disorders/poop-chart-bristol-stool-scale where 1-2 hard stools, 3-4 normal stools, 5-7 soft to watery stools).

When referring to “treatment” it should be understood to encompass any of preventing, reducing, ameliorating, or any combination thereof.

When referring to “promoting development of gut microbiome” is to be understood as encompassing maintaining or developing a normal, balanced, or healthy gut microbiome population. Gut microbiome imbalance may be exhibited by low level of bacteria as well as by an imbalance in the microbiome population etc. as compared to the microbiome of a healthy breast-fed infant. The normal gut microbiome profile is determined based on a pre-determined level from a group of healthy breastfed infants. In some embodiments the method according to the invention is utilized for developing a gut microbiome profile that is essentially equivalent/comparable to that of a breastfed infant.

When referring to “vitamin absorption support” it should be understood to encompass the ability of a composition of the invention to promote and support the absorption of vitamins in the gastrointestinal system of said subject. For example, when said subject is nourished from non-dairy, plant-based diet (in some embodiments also non-soy diet) that has no supplements from animal based food components, such support in vitamin absorption from the nutrition of said subject is essential to the health and well-being of said subject.

In the context of the present application when referring to nutrition of infants it should be understood to refer to the nourishment of infants using food compositions that can substantially simulate human milk or its suitability as a complete or partial substitute for human milk. Such food compositions (infant formula) can be used as the sole food source of an infant.

In the context of the present application when referring to nutrition of toddlers it should be understood to refer to the nourishment of toddlers by the use of food compositions that can provides all required nutritional values for the age group considering the fact that toddler food compositions (toddler formula or follow-on formula or growing up formula) may be a sole food source of a toddler, meal replacement or as a complementary food along with other dietary sources.

In the context of the present application when referring to nutrition it should be understood to refer to the nourishment using food compositions that can provides all required nutritional values for the age group and/or medical condition considering the fact that the food compositions may be a sole food source, meal replacement or as a complementary food along with other dietary sources or as a nutritional supplement.

The required nutritional levels allowed supplements and additional additives are typically regulated in each country by the health authority responsible for food and drug regulation. Thus, compositions of the invention may further include any additional components required under each territorial regulation requirements, such as for example: US Code of Federal Regulations Title 21, Part 107 (Infant formula); Dietary reference intake of US National Academy of Sciences. Institute of Medicine. Food and Nutrition Board; European Commission Directives; Dietary reference intakes by country; Food for Special Medical Purposes by country, Codex Alimentarius guidelines and so forth.

In some embodiments of the invention, said composition provides a nutritional composition that is plant-based. In some embodiments of the invention, said composition provides a nutritional composition that is none-dairy plant-based. In some embodiments of the invention, said composition provides a nutritional composition that is none-soy plant-based. In some embodiments of the invention, said composition provides a nutritional composition that contains no animal-based ingredients.

In some embodiments of the invention said composition provides a nutritional composition made of whole foods.

When referring to “whole food” it should encompass a food ingredient with its original nutritional profile, a food ingredient that was not isolated, fractionated, separated, or any combination thereof.

In some embodiments of the invention said composition provides a nutritional dose for a single feeding portion to a subject in a dry form (powder to be mixed with water (in some embodiments a portion 9-10 g per 60 ml, capable of being administered by a feeding bottle, i.e., drinkable hence consistency and viscosity is low) or in a liquid ready to feed form. The inventors of the present application have found that a composition comprising at least the above two components provide to an infant or a toddler or a subject in need thereof a regulated nutritional feeding that provides the necessary proteins, amino-acids, fat, vitamins, minerals, and other nutrients needed for a single serving of food. i.e, a meal replacement.

When referring to almond, it should be understood to encompass any type of almond tree shelled drupe (Prunus dulcis, syn. Prunus amygdalus Batsch., Amygdalus communis L., Amygdalus dulcis Mill), in any type of form (peeled from seedcoat, unpeeled, grounded, powdered, milled and so forth). The almond provides the protein and lipid component of the composition (including, among others the essential linolenic and alpha linolenic acids).

In some aspects of the invention said almond can be replaced with at least one other nut selected from the following list: Brazil nut, candlenut, cashew, Chilean hazelnut, macadamia, Malabar chestnut, mongongo, peanut, pine nut, pistachio, walnut and yeheb nut, or any combinations thereof with or without almond.

In some embodiments said almond component of a composition of the invention is pre-treated (i.e., prior to the addition of almond component to the composition of the invention) to lower the levels (amount) of phytic acid in said almond. Said pre-treatment of the almond component is performed by at least one of the following: treatment of almond component with phytase enzyme, soaking of said almond component in water, blanching, heating of almond component, pealing of almond, steaming of said almond, bleaching and roasting and any combinations thereof.

Under some embodiments, said reduction or lowering of phytic acid levels is for the removal of substantially all phytic acid from the almond component of a composition of the invention (i.e., said composition comprising no more than 0.001-0.5% wt of phytic acid).

In some embodiments said almond component of a composition of the invention is pre-treated, prior to its addition to the composition, said pre-treatment includes, but is not limited to pealing of almond peal, blanching, steaming of said almond, heating, grounding, hydrolyzing, bleaching, roasting and so forth.

In some further embodiments said almond and/or non-dairy component comprising all essential amino acids are pre-treated prior to their mixture in said composition of the invention for removal of fibers to the suitable levels for the intended population of subjects to be treated.

In some further embodiments said almond and/or non-dairy component comprising all essential amino acids are pre-treated prior to their mixture in said composition of the invention for reducing starch levels to the suitable levels for the intended population of subjects to be treated.

In some further embodiments said almond and/or non-dairy component comprising all essential amino acids are pre-treatment prior to their mixture in said composition of the invention for reduction and/or removal of the content of at least one trace element as compared with natural occurring almond and/or non-dairy component.

In some embodiments, said at least one trace element is selected from Manganese (Mn) and/or Magnesium (Mg).

In other embodiments, said trace element is selected from Arsenic (As), Cadmium (Cd), Lead (Pb), Mercury (Hg), Copper (Cu), Aluminum (Al), Manganese (Mn), Magnesium (Mg) and any combinations thereof.

In further embodiments, said reduction is by at least 20% than its content in the corresponding natural occurring almond and/or non-dairy component.

The term “non-dairy component” refers to a component of a composition of the invention which does not come from any animal source, however, comprises all essential amino acids needed for a composition for the nutrition of an infant, a toddler, an adult or an elderly person.

In some embodiments, a composition of the invention is free of soy or any soy-related components. In other embodiments, a composition of the invention is a non-soy composition.

When referring to the term “non-soy” and/or “free of soy or any soy related components” it should be understood to define that the composition of the invention is devoid of any soy component or any soy derivative or soy-based food element, processed soy food product and any combinations thereof.

When referring to “essential amino acids” (or indispensable amino acids) it should be understood to encompass the amino acids that cannot be synthesized de novo by humans, and therefore must be supplied in the diet. In the context of the present application the list of essential amino acids includes histidine, isoleucine, leucine, lysine, methionine, phenylalanine, threonine, tryptophan and valine.

In some embodiments said at least one non-dairy component comprising all essential amino acids further comprises semi-essential amino acids.

In some embodiments said at least one non-dairy component comprising all essential amino acids is a single non-dairy component comprising all essential amino acids.

In other embodiments said at least one non-dairy component comprising all essential amino acids further comprises carbohydrates.

In other embodiments said at least one non-dairy component comprising all essential amino acids is pre-hydrolyzed (i.e., prior to addition to the composition of the invention). This hydrolyzation is performed for the purpose of hydrolyzing the carbohydrates of said at least one non-dairy component comprising all essential amino acids (such as for example buckwheat), thus reducing its viscosity. In some embodiments, said hydrolyzation of said at least one non-dairy component comprising all essential amino acids is performed by use of an acid or an enzyme (for example amylase).

In some other embodiments said at least one non-dairy component (such as for example buckwheat) is pre-gelatinized prior to its addition of a composition of the invention. This pre-gelatinization process is intended for making the carbohydrates in said non-dairy component to be biologically available to the subject treated with said composition. In some embodiments said pre-gelatinization is performed by at least one of heating, roasting, steaming said at least one non-dairy component prior to its addition to the composition of the invention.

In further embodiments a composition of the invention may include additional non-dairy sources of protein and/or fat including but not limited to pumpkin seeds, sunflower seeds, pinecone seeds, sesame seeds, flax seeds, chia seeds.

In other embodiments said at least one non-dairy component is selected from grain, fabaceae (including but not limited to beans, broad beans, chickpeas, peas, trigonella, caraway and so forth).

In some embodiments, said at least one non-dairy component is at least one type of grain.

In other embodiments said at least one type of grain is cereal grain or pseudocereal grain.

In some embodiments said almond is pre-treated to lower the level of phytic acid in said almond component or composition.

In other embodiments the ratio between almond and said at least one non-dairy component is from about 10:90 to about 90:10.

In other embodiments the ratio between almond and said at least one non-dairy component is from about 30:70 to about 70:30.

In yet further embodiments, almond is present in an amount of at least 10% by weight from the total weight of the composition.

In further embodiments said at least one non-dairy component is present in an amount of at least 5% by weight from the total weight of the composition.

In some embodiments of the invention said composition of the invention is in the form of selected from a powder, a liquid concentrate, ready-to-feed liquid form. Such a composition is designed to be prepared by a caregiver in small batches and fed to the subject.

In some other embodiments said composition is in the form of a dry composition. In other embodiments, said composition is in the form of a water-soluble dry powder. In other embodiments a composition of the invention further comprises a liquid. In some embodiments said liquid is water.

In some embodiments said at least one type of grain is cereal grain selected from the group consisting of maize (corn), rice, wheat, barley, sorghum, millet, oats, triticale, rye, fonio and any combinations thereof.

In other embodiments, said at least one type of grain is pseudocereal grain selected from buckwheat, amaranth and quinoa. In some embodiments said at least one type of grain is buckwheat. In some further embodiments said at least one type of grain is a whole grain.

In some embodiments a composition of the invention further comprises at least one additive selected from vitamins, minerals, trace elements, carbohydrates, lipids, proteins, probiotic agents (micro-organisms which, when administered in adequate amounts, confer a health benefit on the host), prebiotic agents (non-digestible food ingredients that stimulate the growth and/or activity of bacteria in the digestive system in ways claimed to be beneficial to health), nucleotides, poly-unsaturated fatty acids, fluoride, choline, and any combinations thereof (as required by the above noted Codex).

In other embodiments a composition of the invention further comprises at least one additive selected from nucleotides, poly-unsaturated fatty acids, fluoride, choline and any combinations thereof (as required by the above noted Codex).

In other embodiments a composition of the invention further comprises at least one additive selected from a flavoring agent, an oil protective colloid, a plasticizer, an antioxidant, a pro-biotic agent, a pre-biotic agent, an emulsifier, a thickener, an acidity regulator, a packaging gas and any combinations thereof (as required by the above noted Codex).

In some embodiments, said at least one additive is between about 0.001% to about 5% by weight of composition.

### EXAMPLE 1: USE OF PLANT BASED NUTRITIONAL DRINK (BASED ON THE COMPOSITION OF THE INVENTION) FOR YOUNG CHILDREN

A parent survey was conducted among consumers of a product based on the composition of the invention. The mean age was 2 years and average duration of consumption was 5 months. The data set was analyzed as full set for general population and other subsets, such as by age group, children with a medical/clinical background, children with cow milk allergy or lactose intolerance, children without a known food allergy and children previously using hypoallergenic formulas for different reasons.

The data was analyzed in different subsets in order to study whether there is a specific correlation between the observations and a specific medical condition and to evaluate the potential benefit of the composition of the invention for a specific population.

The parent survey included questions related to growth, wellbeing, stool consistency, gastrointestinal symptoms, and rash symptoms.

a. weight gain

| | | | Poor weight gain on | |
|---|---|---|---|---|
| | | Poor weight | nutritional drink | |
| | | gain on previous | based on composition | Problem |
| | | formula/drink | of the invention | solved |
| Full set of general | N = 64 | 112 (17%) | 32 (5%) | 81% |
| population | 8 | | | |
| Children below | N = 15 | 26 (17%) | 3 (2%) | 81% |
| the age of 12 | 3 | | | |
| months | | | | |
| children without a | N = 21 | 33 (15%) | 18 (8%) | 67% |
| known food | 9 | | | |
| allergy | | | | |
| Children with a | N = 18 | 55 (30%) | 12 (6.5%) | 82% |
| medical/clinical | 5 | | | |
| background | | | | |
| children with cow | N = 11 | 29 (25%) | 1 (<1%) | 97% |
| milk allergy or | 8 | | | |
| lactose intolerance | | | | |
| children | N = 10 | 21 (20%) | 1 (<1%) | 95% |
| previously using | 7 | | | |
| hypoallergenic | | | | |
| formulas for | | | | |
| different reasons | | | | |

All the data demonstrate that poor weight gain is observed in young children whether have a known food allergy such as cow milk allergy, soy, corn, fish or an intolerance such as lactose intolerance or have no known food allergy at all.

Though the benefit of solving poor weight gain is more pronounced in children with medical background, especially related to cow milk allergy, there is a significant benefit also for children with poor weight gain but without a known food allergy.

b. Stool consistency

| | | | | Stool consistency | | |
|---|---|---|---|---|---|---|
| | | | | in a scale of 1-7 | | |
| | | | | from very hard | | |
| | | Stool consistency | | stools to watery | | |
| | | in a scale of 1-7 | | stools on | | |
| | | from very hard | | nutritional drink | | |
| | | stools to watery | | based on | | |
| | | stools on previous | | composition of | | |
| | | formula | | the invention | | Improvement |
| Full set of | N = 348 | 1 | 6% | 1 | 2% | From 44% |
| general | | 2 | 14% | 2 | 8% | normal stools |
| population | | 3 | 14% | 3 | 17% | to 63% |
| | | 4 | 31% | 4 | 46% | From 13% |
| | | 5 | 4% | 5 | 8% | extreme hard |
| | | 6 | 24% | 6 | 17% | or watery to |
| | | 7 | 7% | 7 | 1% | 3% |
| children | N = 48 | 1 | 14% | 1 | 2% | From 41% |
| without a | | 2 | 23% | 2 | 10% | normal stools |
| known food | | 3 | 11% | 3 | 25% | to 73% |
| allergy | | 4 | 30% | 4 | 48% | From 21% |
| | | 5 | 0% | 5 | 2% | extreme hard |
| | | 6 | 16% | 6 | 10% | or watery to |
| | | 7 | 7% | 7 | 2% | 4% |
| Children with a | N = 185 | 1 | 10.1% | 1 | 1.1% | From 34% |
| medical/clinical | | 2 | 15.1% | 2 | 7.6% | normal stools |
| background | | 3 | 10.8% | 3 | 16.8% | to 65% |
| | | 4 | 23.7% | 4 | 48.1% | From 24% |
| | | 5 | 2.2% | 5 | 10.3% | extreme hard |
| | | 6 | 24.5% | 6 | 15.1% | or watery to |
| | | 7 | 13.7% | 7 | 1.1% | 2% |
| children with | N = 118 | 1 | 5% | 1 | 0% | From 37% |
| cow milk | | 2 | 6% | 2 | 3% | normal stools |
| allergy or | | 3 | 11% | 3 | 17% | to 71% |
| lactose | | 4 | 26% | 4 | 44% | From 24% |
| intolerance | | 5 | 3% | 5 | 17% | extreme hard |
| | | 6 | 29% | 6 | 17% | or watery to |
| | | 7 | 19% | 7 | 0% | 0% |
| children | N = 51 | 1 | 10.8% | 1 | 0.0% | From 24% |
| previously | | 2 | 10.8% | 2 | 5.9% | normal stools |
| using | | 3 | 8.1% | 3 | 13.7% | 59% |
| hypoallergenic | | 4 | 16.2% | 4 | 45.1% | From 38% |
| formulas for | | 5 | 2.7% | 5 | 13.7% | extreme hard |
| different | | 6 | 24.3% | 6 | 17.6% | or watery to |
| reasons | | 7 | 27.0% | 7 | 3.9% | 4% |

All the data demonstrate that stool consistency differs between children at his age and too hard or too loose stools are observed in young children whether have a known food allergy such as cow milk allergy, soy, corn, fish or an intolerance such as lactose intolerance or have no known food allergy at all. Interestingly, there is a significant benefit for all children regardless of their medical background toward normalizing the stool consistency by reducing the very hard or very loose stools.

c. Gastrointestinal symptoms

| | | Gastro- | |
|---|---|---|---|
| | | intestinal | |
| | | symptoms on | |
| | | previous | |
| | | formula | Improvement |
| Full set of general | N = 348 | 85 (24%) | Improved 29% |
| population | | | Improved significantly |
| | | | 9% |
| | | | Totally gone 27% |
| children without a | N = 48 | 15 (31%) | Improved 27% |
| known food allergy | | | Improved significantly |
| | | | 7% |
| | | | Totally gone 7% |
| Children with a | N = 185 | 68 (37%) | Improved 38% |
| medical/clinical | | | Improved significantly |
| background | | | 12% |
| | | | Totally gone 27% |
| children with cow | N = 63 | 28 (44%) | Improved 39% |
| milk allergy or | | | Improved significantly |
| | | | 7% |
| lactose intolerance | | | Totally gone 39% |
| children previously | N = 51 | 26 (51%) | Improved 39% |
| using | | | Improved significantly |
| hypoallergenic | | | 15% |
| formulas for | | | Totally gone 42% |
| different reasons | | | |

All the data demonstrate that gastrointestinal symptoms are observed in young children whether have a known food allergy such as cow milk allergy, soy, corn, fish or an intolerance such as lactose intolerance or have no known food allergy at all.

Though the frequency of gastrointestinal symptoms observed in children with a medical background especially related to cow milk allergy, is higher, there is a significant benefit also for children without a background of food allergy.

d. Skin rash symptoms

| | | Skin rash | |
|---|---|---|---|
| | | symptoms on | |
| | | previous formula | Improvement |
| Full set of general | N = 348 | 73 (21%) | 54% |
| population | | | |
| children without a | N = 48 | 8 (17%) | 63% |
| known food | | | |
| allergy | | | |
| Children with a | N = 185 | 62 (34%) | 81% |
| medical/clinical | | | |
| background | | | |
| children with cow | N = 63 | 29 (46%) | 83% |
| milk allergy or | | | |
| lactose intolerance | | | |
| children | N = 51 | 17 (33%) | 82% |
| previously using | | | |
| hypoallergenic | | | |
| formulas for | | | |
| different reasons | | | |

All the data demonstrate that skin rash symptoms are observed in young children whether have a known food allergy such as cow milk allergy, soy, corn, fish or an intolerance such as lactose intolerance or have no known food allergy at all.

Though the frequency of skin rash symptoms observed in children with a medical background especially related to cow milk allergy, is higher, there is a significant benefit also for children without a background of food allergy.

The improvement in skin rash symptoms was evaluated also based on frequency, length of episodes and severity. The table below presents representative before and after data.

| | Prior using | Since | | Sstudent's |
|---|---|---|---|---|
| | Else | using Else | | t-test |
| N = 62 | Mean ± SD | Mean ± SD | Change | P-value |
| Frequency | 1.9 ± 2.3 | 0.8 ± 1.3 | −1.1 | <0.0001 |
| (# new rash | | | | |
| occurrences per week) | | | | |
| Length of rash | 13.7 ± 20.4 | 4.9 ± 12.8 | −8.8 | <0.0001 |
| (hours per episode) | | | | |
| Rash Severity | 2.6 ± 1.2 | 1.6 ± 0.9 | −1 | <0.0001 |
| (scale of 1-5, from | | | | |
| low to high) | | | | |

### EXAMPLE 2: BLOOD GLUCOSE AND VITAMIN LEVELS IN PIGLETS FED DIFFERENT DIETS

A. A neonatal piglet model was used to evaluate the safety and efficacy of the composition of the invention compared to a diet based on standard commercial infant formula. Piglets were fed on one of the two diets for 3 weeks, from post-natal day 2 to post-natal day 21. Blood samples were taken weekly and analyzed for CBC, chemistry, vitamins, hormones, etcGlucose levels were reported in the table below:

| | Week 1 | Week 2 | Week 3 |
|---|---|---|---|
| Diet based on commercial | 110 ± 6.5 | 138 ± 15 | 129 ± 11 |
| standard infant formula | | | |
| Diet based on the composition | 114 ± 9.4 | 115 ± 9.6 | 124 ± 8.7 |
| of the invention | | | |
| p-value | 0.34 | 0.0014 | 0.29 |

The table above describes the stability of glucose levels during the study in the group fed the diet based on the composition of the invention compared to the control diet where an elevated level is reported following two weeks of feeding.

The glucose levels in the control group ranged from 99-173 mg/dl and in the composition of the invention group from 98-140 mg/dL. The normal concentration of glucose in the plasma of newborn infants is 2.5 mmol/l (45 mg/dl) to 7.0 mmol/l (126 mg/dl). Though the average measured glucose levels in this study are within this range, more piglets in the control group had plasma glucose levels higher that the above as compared to the composition of the invention group.

B. Vitamin D and Vitamin K levels at the end of the study were reported in the table below:

| | Vitamin D | Vitamin K |
|---|---|---|
| Diet based on commercial | 24.1 (ng/ml) | 204.1 (pg/ml) |
| standard infant formula | | |
| Diet based on the composition of | 26.1 (ng/ml) | 206.9 (pg/ml) |
| the invention | | |

The study results shown in the table above demonstrate the ability of the composition of the invention to support normal vitamin absorption similar to absorption in animals fed a commercial known composition.

### EXAMPLE 3: MICROBIOME DIVERSITY IN PIGLETS FED DIFFERENT DIETS

A neonatal piglet model was used to evaluate the safety and efficacy of the composition of the invention compared to a diet based on standard commercial infant formula. Piglets were fed on one of the two diets for 3 weeks, from post-natal day 2 to post-natal day 21. Fecal and intestinal contents from different regions were processed for microbiota data collection and analyses. DNA isolation, 16S rRNA library preparation, and sequencing were carried out by RTL Genomics (Lubbock, TX, USA).

At the phylum level, both diets showed similar microbiota composition. In duodenum, Firmicutes was the predominant phylum in both diet groups, whereas Proteobacteria was the major phylum detected in jejunum and ileum. In the large intestine, Bacteroidetes was the predominant phylum within the microbiota composition.

The Bray-Curtis dissimilarity showed no significant difference in beta diversity between two diet groups in any regions of the intestine. The alpha diversity, which measures the diversity within the samples also showed there was no significant difference in the gastrointestinal regions and in the feces between the plant-based and dairy-based formula diet fed piglets.

The above results show that the plant-based diet supported normal microbiome development in a neonatal animal model.

The study results demonstrate the ability of the composition of the invention to support normal microbiome development similar to that of animals fed a commercial known composition.

### EXAMPLE 4: IN VITRO DIGESTIBILITY MODEL OF A FORMULA BASED ON COMPOSITION OF THE INVENTION COMPARED TO STANDARD COW MILK-BASED FORMULA

Set up of in vitro digestion experiments: Auto titration unit was set up to mimic semi-dynamic infant gastro-duodenal digestion. Enzymes, bile salts and simulated digestive fluids were set to be according to the INFOGEST protocol. Specifically, each digestion was started from 63 ml “Else Nutrition” formula sample (9.45 gr powder in 63 ml DW) and 37 ml Simulated Gastric Fluids (SGF) for one hour. Gastric phase was followed by intestinal digestion for another one hour containing 50 ml from the gastric digesta and 50 ml of Simulated Duodenal Fluids (SDF). SGF contains ions and pepsin (Porcine gastric pepsin-35 kDa), SDF contains ions, proteolytic enzymes, and amylase (Porcine pancreatic trypsin-23.8 kDa, Bovine pancreatic α-chymotrypsin-25 kDa, α-Amylase from porcine pancreas-51 kDa), and bile salts. Digesta aliquots were collected at time points: G0, G30 min and G60 min during the gastric phase, and D30 min and D60 min from the duodenal phase. PapstatineA+TCA and PMSF+TCA were used to neutralize enzymes from the stomach and duodenum, respectively.

Samples: ES3F is the composition of the invention (shown in FIG. 1A), 003-19 (shown in FIG. 1B) is a cow milk based infant formula, and 003-19B (shown in FIG. 1C) is soy based infant formula. From all time points, protein degradation through SDS-PAGE (12% Acrylamide) was measured.

Results: gastric proteolytic digestion shows a typical” smear” pattern of digested proteins with MW between 10 kDa to 170 kDa. All plant samples demonstrate a relatively high endurance to digestion compared to other food proteins, such as whey and egg proteins. Sample 003-19, the standard cow milk based infant formula presented three protein bands of 72 kDa, 34 kDa and 26 kDa that disappear after 30 minutes of simulated digestion. Under intestinal conditions, all formulas are almost fully digested and just proteins and peptides under 17 kDa are found after 30 minutes of digestion.

Conclusion: the protein digestion from the formula based on the composition of the invention is conducted mainly in the intestine compared to regular cow milk protein digestion that is digested to a significant part by the gastric enzymes.

1.-28. (canceled)

29. A method of providing nutrition of a subject suffering from at least one disorder selected from skin problem, frequent rashes, gastrointestinal disorder, frequent loose stool, frequent hard stool, constipation, growth problem, poor weight gain, failure to thrive, uncontrolled blood glucose, hyperglycemia, in need of vitamin absorption support, in need of microbiome development support and any combinations thereof; said composition comprising almond and at least one non-dairy component comprising all essential amino acids, wherein said composition is a non-dairy composition.

30. A method of treating at least one disorder selected from skin problem, frequent rashes, gastrointestinal disorder, frequent loose stool, frequent hard stool, constipation, growth problem, poor weight gain, failure to thrive, uncontrolled blood glucose, hyperglycemia, and any combinations thereof; said composition comprising almond and at least one non-dairy component comprising all essential amino acids, wherein said composition is a non-dairy composition formula.

31. A composition according to claim 29 or 30, wherein said subject is nourished by a plant-based non-dairy nutrition.

32. A composition according to claim 29 or 30, wherein the formula is the sole source of nutrition of said subject.

33. A composition according to claim 29 or 30, wherein the formula is a supplement of the nutrition or a complementary nutrition for the subject.

34. A composition according to claim 29 or 30, wherein said at least one non-dairy component comprising all essential amino acids further comprises semi-essential amino acids.

35. A composition according to claim 29 or 30, wherein said at least one non-dairy component comprising all essential amino acids further comprises carbohydrates.

36. A composition according to claim 29 or 30, wherein said at least one non-dairy component is selected from grain, fabaceae.

37. A composition according to claim 29 or 30, being free of soy or any soy-related component.

38. A composition according to claim 29 or 30, wherein the ratio between almond and said at least one non-dairy component is from about 10:90 to about 90:10.

39. A composition according to claim 29 or 30, wherein the almond is present in an amount of at least 10% by weight from the total weight of the composition.

40. A composition according to claim 29 or 30, wherein said at least one non-dairy component is present in an amount of at least 5% by weight from the total weight of the composition.

41. A composition according to claim 29 or 30, being in the form of a dry composition.

42. A composition according to claim 29 or 30, being in the form of a water-soluble dry powder.

43. A composition according to claim 29 or 30, further comprising water.
